(19) United States
(12) Patent Application Publication
(10) Pub. No.: US 2014/0124485 A1
(43) Pub. Date: May 8, 2014

(54) RESISTANCE SPOT WELDING METHOD FOR A LAP-JOINT OF MULTI-METAL SHEETS

(71) Applicant: NATIONAL PINGTUNG UNIVERSITY OF SCIENCE AND TECHNOLOGY, Pingtung County (TW)

(72) Inventors: Kuang-Hung Tseng, Pingtung County (TW); Yung-Chuan Chen, Pingtung County (TW)

(73) Assignee: NATIONAL PINGTUNG UNIVERSITY OF SCIENCE AND TECHNOLOGY, Pingtung County (TW)

(21) Appl. No.: 14/067,530

(22) Filed: Oct. 30, 2013

(30) Foreign Application Priority Data
Nov. 2, 2012 (TW) 101140809
Jul. 11, 2013 (TW) 102124939

(51) Int. Cl. B23K 11/30

(52) U.S. Cl. CPC B23K 11/30
USPC 219/117.1

(57) ABSTRACT

A resistance spot welding method for a lap joint multi-metal sheets which may improve the welding efficiency and nugget quality comprises: coating a joining zone of one of two mutually facing surfaces of two adjacent metal sheets with an active agent with high resistivity to form a welding region, and clamping the welding region with an upper welding electrode and a lower welding electrode and providing an electric current into the welding region. The active agent with high resistivity generates high heat energy to melt the joining zone and join the two adjacent metal sheets. The active agent with high resistivity has a resistivity much greater than a resistivity of each of the two metal sheets, and the active agent with high resistivity consists of multi-component powders and an organic solvent.

### BACKGROUND OF THE INVENTION

1. Field of the Invention

The present invention relates to a resistance spot welding method for a lap-joint of multi-metal sheets and, more particularly, to a resistance spot welding method using an active agent with high resistivity for a lap joint of multi-metal sheets.

2. Description of the Related Art

Welding technologies for a lap joint of multi-metal sheets are widely used in manufacturing industries, particularly in welding processes in the automobile industry, and a resistance spot welding technology is most widely used.

In the conventional resistance spot welding process, in addition to the clamping force between a pair of the welding electrodes, the welding current, and the welding time, the property, thickness and surface of each metal sheet are the other issues must be considered when welding of the multi-metal sheets to find out whether multi-pass spot welding procedure or a high electrode force or a high welding current is required to accomplish welding of the multi-metal sheets for a lap-joint. However, the multi-pass spot welding procedure is very complicated, and a high welding current may cause nugget expulsion or deep depression. Furthermore, shrinkage voids, incomplete fusion, and cracks are apt to occur due to uneven heat energy distribution or the difference of local cooling rates in the nugget. Furthermore, due to different contact resistance of two of the multi-metal sheets to be joined, the heat energy caused by the resistance is liable to accumulate in a zone with a higher contact resistance, such that the nugget offsets during its growth, leading to a difference in the nugget diameter or area and significantly and adversely affecting the nugget quality of the multi-metal sheet.

Furthermore, high temperature resulting from the conventional resistance spot welding process providing high electric current often degrades structural strength and hardness of the multi-metal sheets, such that recesses are apt to be formed in outer faces of the multi-metal sheets under the action of the clamping force imparted to the multi-metal sheets by the welding electrodes. The multi-metal sheets would be damaged if the depth of the nugget depression is more than 20% of the thickness of the multi-metal sheet.

Thus, a need exists for a novel spot welding method for a lap joint of multi-metal sheets.

### SUMMARY OF THE INVENTION

The primary objective of the present invention is to mitigate and/or obviate the above disadvantages by providing a resistance spot welding method for a lap joint of multi-metal sheets to change the contact resistance of two adjacent metal sheets, increasing the nugget diameter or area, thereby providing enhanced welding performance.

Another objective of the present invention is to provide a resistance spot welding method for a lap joint of multi-metal sheets, wherein low welding current is provided, thereby reducing drawbacks of the shrinkage voids, incomplete fusion, and cracks, further providing enhanced nugget quality.

The present invention fulfills the above objectives by providing a resistance spot welding method for a lap joint of multi-metal sheets comprising coating a joining zone of one of two mutually facing surfaces of two adjacent metal sheets with an active agent with high resistivity to form a welding region, and clamping the welding region with an upper welding electrode and a lower welding electrode and providing an electric current into the welding region. The active agent with high resistivity generates high heat energy to melt the joining zone and join the two adjacent metal sheets. The active agent with high resistivity has a resistivity much greater than a resistivity of each of the two metal sheets, and the active agent with high resistivity consists of multi-component powders and an organic solvent.

Preferably, the multi-component powders are made of metal compounds and non-metal compounds, and a weight ratio of the multi-component powders to the organic solvent is 2:3.

The multi-component powders preferably are oxides, sulfides, carbonates, and halides, and more preferably are silicon oxide, titanium oxide, iron oxide, molybdenum sulfide, manganese carbonate, and halides.

Preferably, the multi-component powders of the active agent with high resistivity includes 30-50 wt % of silicon oxide, 20-40 wt % of titanium oxide, 5-20 wt % of iron oxide, 10-25 wt % of molybdenum sulfide, 10-15 wt % of manganese carbonate, and 5-10 wt % of halides and is mixed with the organic solvent to form a paint-like consistency.

Preferably, the resistivity of the active agent with high resistivity is 10¹⁵-10²⁵ times of the resistivity of each of the two metal sheets.

Preferably, the organic solvent is methanol, ethanol, isopropanol or acetone.

Preferably, the joining zone coated with the active agent with high resistivity has a coating amount of 0.00009 g/cm² 0.00099 g/cm², and the joining zone coated with the active agent with high resistivity has a width larger than a tip diameter of each of the upper and lower welding electrodes.

Based on a same technical concept, the present invention further comprises: coating a joining zone of one of two mutually facing surfaces of two adjacent metal sheets with an active agent with high resistivity to form a welding region, and clamping the welding region with an upper welding electrode and a lower welding electrode and providing an electric current into the welding region. The active agent with high resistivity generates high heat energy to melt the joining zone and join the two adjacent metal sheets. The active agent with high resistivity has a resistivity much greater than a resistivity of each of the two metal sheets, the active agent with high resistivity consists of multi-component powders and an organic solvent and both the two adjacent metal sheets coating the active agent do not contact the upper welding electrode.

The resistance spot welding method according to the present invention not only increases the nugget diameter or area through stable heat energy caused by the resistance but also avoids nugget expulsion and deep depression resulting from the impact of high welding current. A better welding efficiency is obtained through the single-pass spot welding method. Furthermore, the resistance spot welding method for a lap joint of multi-metal sheets according to the present invention can mitigate and/or obviate the disadvantages of shrinkage voids, incomplete fusion, and cracks, providing enhanced nugget quality while increasing the joint strength of the resultant multi-metal sheets.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1a is an exploded, perspective view of three metal sheets, with a joining zone of one of two mutually facing surfaces of two adjacent metal sheets coated with an active agent with high resistivity.

FIG. 1b is a perspective view illustrating the metal sheets clamped between a pair of the welding electrodes.

FIG. 2a is a diagram showing the resistance spot welding method of the three metal sheets.

FIG. 2b is a diagram showing the resistivity distribution of the three metal sheets according to FIG. 2a.

FIG. 2c is a diagram showing the temperature distribution of the three metal sheets according to FIG. 2a.

FIG. 3a is a diagram showing the resistance spot welding method of the three metal sheets.

FIG. 3b is a diagram showing the resistivity distribution of the three metal sheets according to FIG. 3a.

FIG. 3c is a diagram showing the temperature distribution of the three metal sheets according to FIG. 3a.

FIG. 4a is a diagram showing the resistance spot welding method of the three metal sheets.

FIG. 4b is a diagram showing the resistivity distribution of the three metal sheets according to FIG. 4a.

FIG. 4c is a diagram showing the temperature distribution of the three metal sheets according to FIG. 4a.

FIG. 5 is metallographic images of a nugget of metal sheets joined by the conventional resistance spot welding process and the resistance spot welding method according to the present invention with output electric currents of 5.0 kA and 6.1 kA.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

A resistance spot welding method for joining a multi-metal sheet according to the present invention can be used to join metal sheets with different properties or different thicknesses, mainly automobile high-strength steel sheets, which can be processed with the resistance spot welding method for joining a multi-metal sheet for application in the traffic conveyance industry to increase the welding productivity and the nugget quality.

The term “nugget” referred to hereinafter means a zone through which an electric current passes during resistance spot welding process, which can be appreciated by one having ordinary skill in the art.

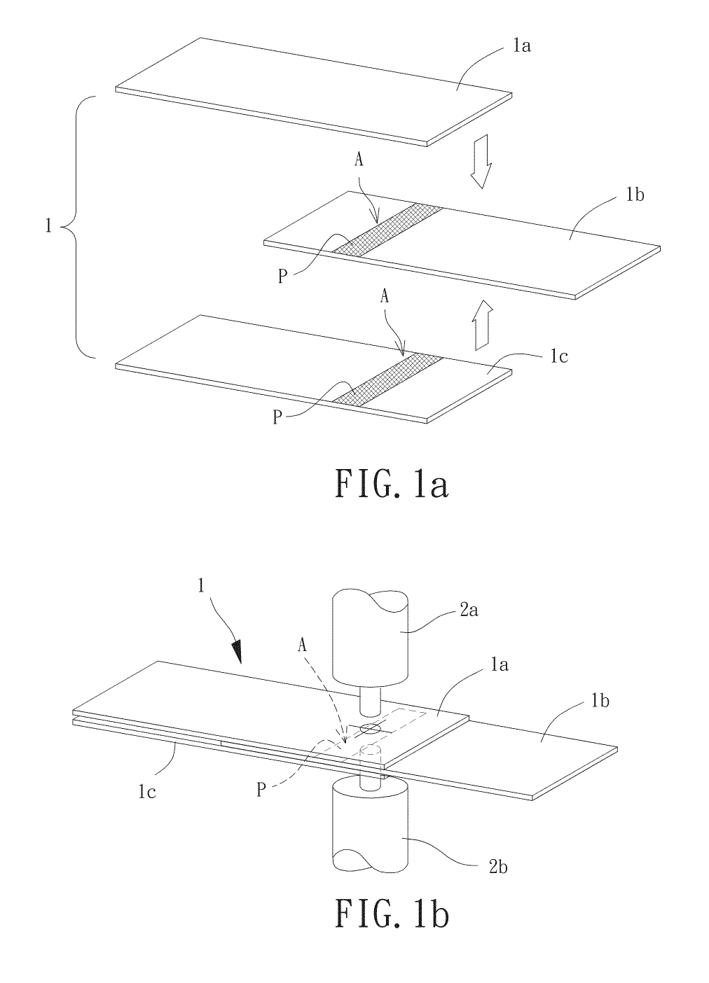

The resistance spot welding method for a lap joint of multi-metal sheets according to the present invention includes coating a joining zone of one of two mutually facing surfaces respectively of two adjacent metal sheets 1a and 1b; 1b and 1c with an active agent with high resistivity “P” to form a welding region “A”, as shown in FIG. 1a. The active agent with high resistivity “P” has a resistivity much greater than a resistivity of each of the two metal sheets 1a and 1b; 1b and 1c. For example, the resistivity of silicon dioxide powder is 1.0×10¹⁸ Ω-cm, the resistivity of titanium oxide powder is 1.0×10¹² Ω-cm, the resistivity of high-strength steel sheet is 2.8×10⁻⁵ Ω-cm and the resistivity of stainless steel sheet is 7.4×10⁻⁵ Ω-cm. Preferably, the resistivity of the active agent with high resistivity “P” is 10¹⁵-10²⁵ of times the resistivity of each of the two metal sheets 1a and 1b; 1b and 1c to effectively increase the contact resistance between the metal sheets 1a and 1b; 1b and 1c. The active agent with high resistivity “P” consists of multi-component powders and an organic solvent. Preferably, the multi-component powders are made of metal compounds and non-metal compounds, and a weight ratio of the multi-component powders to the organic solvent is 2:3. The multi-component powders can be oxides, sulfides, carbonates, and halides, such as silicon oxide, titanium oxide, iron oxide, molybdenum sulfide, manganese carbonate and halides, or any metal or non-metal compounds with a relatively high resistivity relative to the metal sheets 1a, 1b, 1c. The organic solvent can be a volatile liquid, such as methanol, ethanol, isopropanol or acetone.

In this embodiment, the multi-component powders of the active agent with high resistivity “P” includes 30-50 wt % of silicon oxide, 20-40 wt % of titanium oxide, 5-20 wt % of iron oxide, 10-25 wt % of molybdenum sulfide, 10-15 wt % of manganese carbonate, and 5-10 wt % of halides. The multi-component powders are mixed with methanol (a weight ratio of the multi-component powders to methanol is 2:3) to obtain the active agent with high resistivity “P” in a paint-like consistency. In the example shown in FIG 1a, the method is used to join three metal sheets 1a, 1b, and 1c together to obtain a multi-metal sheet 1. The active agent with high resistivity “P” is coated on a joining zone of a surface of the metal sheet 1c facing metal sheet 1b and on a joining zone of a surface of the metal sheet 1b facing the metal sheet 1a, forming a welding region “A” on each of the surfaces of the metal sheets 1b and 1c. The metal sheets 1a, 1b, and 1c are stacked with the welding regions “A” aligned with each other.

Preferably, the active agent with high resistivity “P” is thick enough to cover the surface luster of the metal sheets 1b, 1c. Preferably, the coating amount of the active agent with high resistivity “P” is in a range of 0.00009 g/cm²-0.00099 g/cm². Namely, the welding regions “A” are evenly covered to increase the accuracy of the electric current provided into the welding regions “A”.

Particularly, the active agent with high resistivity “P” can be (but not necessarily) applied throughout the overall surface of one of the two mutually facing surfaces respectively of two adjacent metal sheets 1a and 1b; 1b and 1c. A person skilled in the art can slightly adjust the coating position and the coating thickness of the active agent with high resistivity “P” based on the property and thickness of each metal sheet 1a, 1b, 1c for the purposes of increasing the nugget diameter or area for thicker metal sheets.

After the metal sheets 1a, 1b, 1c are coated with the active agent with high resistivity “P” and stacked with the welding regions “A” aligned with each other, an upper welding electrode 2a and a lower welding electrode 2b are used to clamp the welding regions “A”, as shown in FIG. 1b. An electric current is provided into the welding regions “A”. The active agent with high resistivity “P” generates high heat energy to melt the joining zone between each two adjacent metal sheet 1a and 1b, 1b and 1c, joining two adjacent metal sheets 1a and 1b; 1b and 1c by the joining zone. The joining zone coated with the active agent with high resistivity has a width larger than a tip diameter of each of the upper and lower welding electrodes. In this example, a middle-frequency direct current (MFDC) resistance spot welding equipment is used, with the tip diameter of each welding electrode being 6.0 mm, with the highest welding current being 6.1 kA, and with the welding electrode clamping force being 350 kgf.

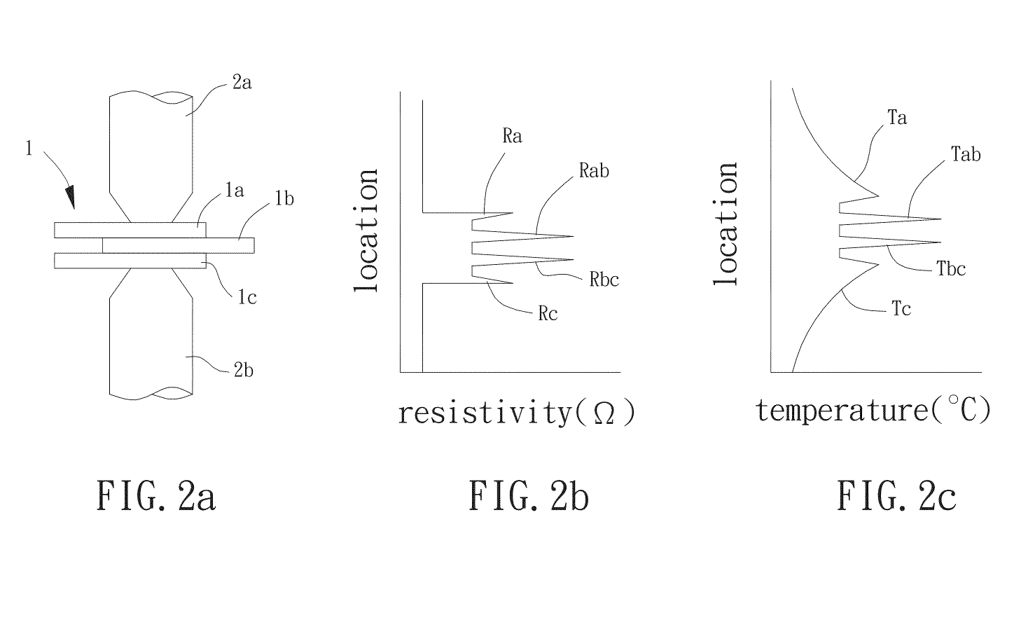

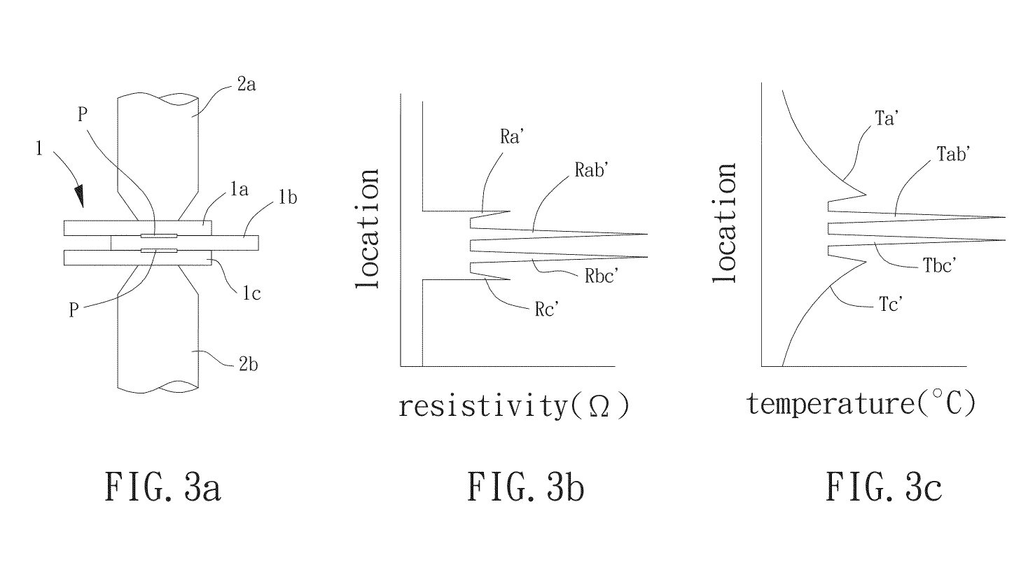

As mentioned above, the upper and lower welding electrodes 2a and 2b clamp the outer metal sheets 1a and 1c, with the tip of each of the upper and lower welding electrodes 2a and 2b facing the welding regions “A”. After adjusting the electric current and the clamping force of the upper and lower welding electrodes 2a and 2b, the electric current is provided into the welding regions “A”. As shown in FIG. 2a, no active agent with high resistivity “P” is coated on the metal sheets 1a, 1b and 1c. The resistivity and the temperature of the metal sheets are shown in FIGS. 2b and 2c, respectively. Resistivity “Ra” and temperature “Ta” are measured on the upper surface of the metal sheet 1a which contacts the upper welding electrode 2a, resistivity “Rab” and temperature “Tab” are measured on the mutually facing surfaces of the metal sheets 1a and 1b, resistivity “Rbc” and temperature “Tbc” are measured on the mutually facing surfaces of the metal sheets 1b and 1c, and resistivity “Rc” and temperature “Tc” are measured on the lower surface of the metal sheet 1c which contacts the lower welding electrode 2b. Referring to FIGS. 2b and 2c, resistivity “Rab” and resistivity “Rbc” is larger than resistivity “Ra” and resistivity “Rc”, and temperature “Tab” and temperature “Tbc” is larger than temperature “Ta” and temperature “Tc”. Furthermore, in FIG. 3a, the active agent with high resistivity “P” is coated on the metal sheets 1a, 1b and 1c. Since the electric current provided into the welding regions “A” is restricted by the high resistance of the active agent with high resistivity “P”, high heat energy is generated between the metal sheets 1a and 1b and between the metal sheets 1b and 1c. Resistivity “Rab’ and resistivity “Rbc' measured on the mutually facing surfaces of the metal sheets 1a and 1b, and 1b and 1c, respectively are significantly larger than resistivity “Rab” and resistivity “Rbc”. Temperature “Tab' and temperature “The' are significantly larger than temperature “Tab” and temperature “Tbc”, as shown in FIGS. 3b and 3c. Thus, the high heat energy caused by the resistance melts the joining zones of the metal sheets 1a, 1b, and 1c, and the metal sheets 1a, 1b, and 1c tightly join with each other under the pressure from the upper and lower welding electrodes 2a and 2b.

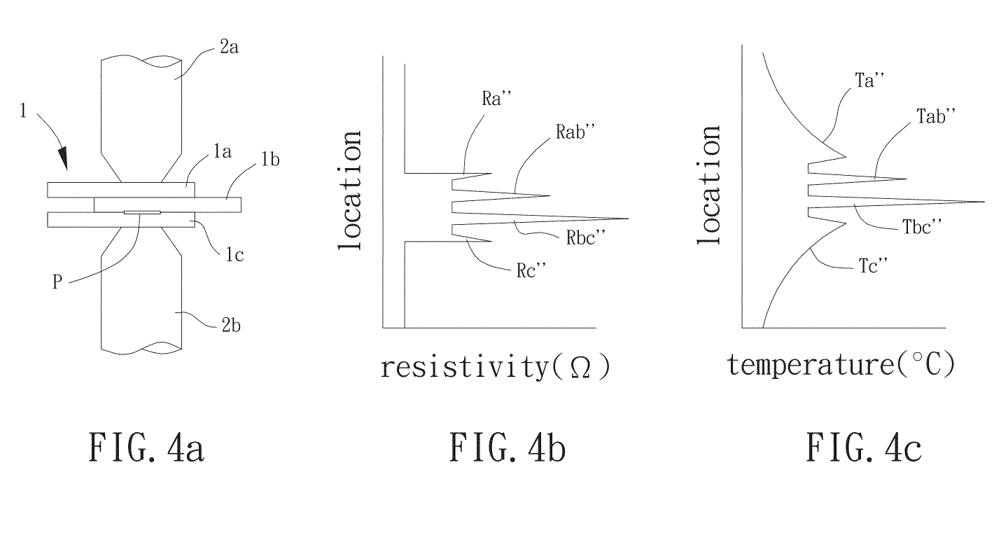

Referring to FIG. 4a, the active agent with high resistivity “P” is only coated between the metal sheets 1b and 1c, but not between the metal sheets 1a and 1b. That is, the active agent with high resistivity “P” is only coated between the metal sheets not contacting the upper welding electrode 2a. High heat energy is also generated between the metal sheets 1a and 1b and between the metal sheets 1b and 1c, as shown in FIGS. 4b and 4c). Thus, the high heat energy melts the joining zones of the metal sheets 1a, 1b, and 1c, and the metal sheets 1a, 1b, and 1c tightly join with each other under the clamping force from the upper and lower welding electrodes 2a and 2b.

Thus, the resistance spot welding method for a lap joint of multi-metal sheets according to the present invention can significantly increase the heat energy by increasing the contact resistance between two adjacent metal sheets through use of the active agent with high resistivity “P”. Namely, the heat energy is liable to accumulate in the zone having high contact resistance during conventional resistance spot welding process, causing uneven distribution of heat energy. By applying the active agent with high resistivity “P” between two adjacent metal sheets with low contact resistance, the contact resistance between the two adjacent metal sheets can be increased by the high resistance of the active agent with high resistivity “P” to generate stable and evenly distributed heat energy under low electric current, achieving production of the multi-metal sheets by single-pass welding.

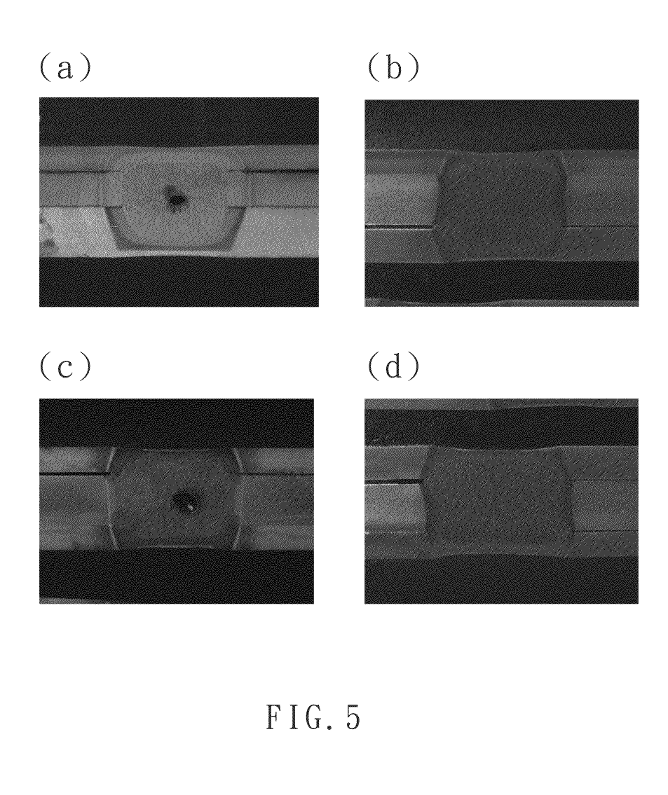

The differences between the conventional resistance spot welding process and the resistance spot welding method according to the present invention are shown in FIG. 5. With reference to panel (a), in a metal sheet joined by the conventional resistance spot welding process with an output current of 5.0 kA, shrinkage void is found in the center of nugget of the metal sheets as well as incomplete fusion at the outer metal sheets. By contrast, with the same output current of 5.0 kA, the nugget of the metal sheets joined by the method according to the present invention were complete and flawless, providing excellent nugget quality, as shown in panel (c). When the output is increased to 6.1 kA, in the metal sheets joined by the conventional resistance spot welding process, shrinkage void still existed in the center of nugget, as shown in panel (b). By contrast, with the same output current of 6.1 kA, the nugget diameter or area of the metal sheets joined by the method according to the present invention were increased significantly, providing excellent nugget quality, as shown in panel (d).

Table 1 shows evaluation of differences in nugget diameter by peel tests carried on multi-metal sheets with thickness of 1.8 mm produced from the conventional resistance spot welding process and the resistance spot welding method according to the present invention, respectively.

TABLE 1

| | |
|---|---|
| welding current | nugget diameter (mm) |

| (kA) | conventional | the invention |
|---|---|---|
| 4.6 | NF | 0.96 |
| 5.0 | 2.03 | 2.63 |
| 5.3 | 3.14 | 3.98 |
| 5.8 | 3.91 | 4.89 |
| 6.1 | 4.32 | 5.36 |

As can be seen from Table 1, by using the active agent with high resistivity “P” in the present invention, the nugget diameter can be increased by using a lower welding current.

Conclusively, the resistance spot welding method according to the present invention not only increases the nugget diameter or area through stable heat energy but also avoids nugget expulsion or deep depression resulting from the impact of high welding current. A better welding efficiency is obtained through the single-pass spot welding method. Furthermore, the resistance spot welding method for a lap-joint of multi-metal sheets according to the present invention can mitigate and/or obviate the disadvantages of shrinkage voids in the center of nugget, incomplete fusion, and cracks, providing enhanced nugget quality while increasing the joint strength of the resultant multi-metal sheets.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A resistance spot welding method for a lap joint of multi-metal sheets comprising:
coating a joining zone of one of two mutually facing surfaces of two adjacent metal sheets with an active agent with high resistivity to form a welding region; and
clamping the welding region with an upper welding electrode and a lower welding electrode and providing an electric current into the welding region, with the active agent with high resistivity generating high heat energy to melt the joining zone and join the two adjacent metal sheets,
wherein the active agent with high resistivity having a resistivity much greater than a resistivity of each of the two metal sheets, and the active agent with high resistivity consists of multi-component powders and an organic solvent.

2. The resistance spot welding method as claimed in claim 1, wherein the multi-component powders are made of metal compounds and non-metal compounds, and a weight ratio of the multi-component powders to the organic solvent is 2:3.

3. The resistance spot welding method as claimed in claim 2, wherein the multi-component powders are oxides, sulfides, carbonates, and halides.

4. The resistance spot welding method as claimed in claim 3, wherein the multi-component powders are silicon oxide, titanium oxide, iron oxide, molybdenum sulfide, manganese carbonate, and halides.

5. The resistance spot welding method as claimed in claim 4, wherein the multi-component powders of the active agent with high resistivity consists of 30-50 wt % of silicon oxide, 20-40 wt % of titanium oxide, 5-20 wt % of iron oxide, 10-25 wt % of molybdenum sulfide, 10-15 wt % of manganese carbonate, and 5-10 wt % of halides and are mixed with the organic solvent to form a paint-like consistency.

6. The resistance spot welding method as claimed in claim 1, wherein the resistivity of the active agent with high resistivity is 10¹⁵-10²⁵ times of the resistivity of each of the two metal sheets.

7. The resistance spot welding method as claimed in claim 1, wherein the organic solvent is methanol, ethanol, isopropanol or acetone.

8. The resistance spot welding method as claimed in claim 1, wherein the joining zone coated with the active agent with high resistivity has a coating amount of 0.00009 g/cm²-0.00099 g/cm².

9. The resistance spot welding method as claimed in claim 1, wherein the joining zone coated with the active agent with high resistivity has a width larger than a tip diameter of each of the upper and lower welding electrodes.

10. A resistance spot welding method for a lap joint of multi-metal sheets comprising:
coating a joining zone of one of two mutually facing surfaces of two adjacent metal sheets with an active agent with high resistivity to form a welding region; and
clamping the welding region with an upper welding electrode and a lower welding electrode and providing an electric current into the welding region, with the active agent with high resistivity generating high heat energy to melt the joining zone and join the two adjacent metal sheets,
wherein the active agent with high resistivity having a resistivity much greater than a resistivity of each of the two metal sheets, the active agent with high resistivity consists of multi-component powders and an organic solvent and both the two adjacent metal sheets coating the active agent do not contact the upper welding electrode.

11. The resistance spot welding method as claimed in claim 10, wherein the multi-component powders are made of metal compounds and non-metal compounds, and a weight ratio of the multi-component powders to the organic solvent is 2:3.

12. The resistance spot welding method as claimed in claim 11, wherein the multi-component powders are oxides, sulfides, carbonates, and halides.

13. The resistance spot welding method as claimed in claim 12, wherein the multi-component powders are silicon oxide, titanium oxide, iron oxide, molybdenum sulfide, manganese carbonate, and halides.

14. The resistance spot welding method as claimed in claim 13, wherein the multi-component powders of the active agent with high resistivity consists of 30-50 wt % of silicon oxide, 20-40 wt % of titanium oxide, 5-20 wt % of iron oxide, 10-25 wt % of molybdenum sulfide, 10-15 wt % of manganese carbonate, and 5-10 wt % of halides and are mixed with the organic solvent to form a paint-like consistency.

15. The resistance spot welding method as claimed in claim 10, wherein the resistivity of the active agent with high resistivity is 10¹⁵-10²⁵ times of the resistivity of each of the two metal sheets.

16. The resistance spot welding method as claimed in claim 10, wherein the organic solvent is methanol, ethanol, isopropanol or acetone.

17. The resistance spot welding method as claimed in claim 10, wherein the joining zone coated with the active agent with high resistivity has a coating amount of 0.00009 g/cm²-0.00099 g/cm².

18. The resistance spot welding method as claimed in claim 10, wherein the joining zone coated with the active agent with high resistivity has a width larger than a tip diameter of each of the upper and lower welding electrodes.
